(19) United States
(12) Patent Application Publication
(10) Pub. No.: US 2018/0366123 A1
(43) Pub. Date: Dec. 20, 2018

(54) Representing Results From Various Speech Services as a Unified Conceptual Knowledge Base

(71) Applicant: Nuance Communications, Inc., Burlington, MA (US)

(72) Inventors: Munir Nikolai Alexander Georges, Kehl (DE); Friederike Eva Anabel Niedtner, Montréal (CA); Josef Damianus Anastasiadis, Aachen (DE); Oliver Bender, Aachen (DE); Jeroen Maurice Decroos, Aachen (DE)

(21) Appl. No.: 15/779,502

(22) PCT Filed: May 31, 2016
(86) PCT No.: PCT/US2016/035050

§ 371 Date: May 25, 2018

Related U.S. Application Data
(60) Provisional application No. 62/261,762, filed on Dec. 1, 2015.

(51) Int. Cl. G10L 15/32; G10L 15/22

(52) U.S. Cl. CPC G10L 15/32; G10L 2015/223; G10L 15/22

(57) ABSTRACT

Systems and methods for processing results from plural speech services are described. A method includes receiving speech service results from plural speech services and service specifications corresponding to the speech service results. The results are at least one data structure representing information according to functionality of the speech services. The service specifications describe the data structure and its interpretation for each speech service. The speech service results are encoded into a unified conceptual knowledge representation of the results based on the service specification. The unified conceptual knowledge representation is provided to an application module. A method includes assessing speech service results received asynchronously from plural speech services to determine, based on a reliability measure, whether there is a reliable result among the speech service results received. If there is a reliable result, it is provided to an application module; otherwise, the method continues to assess the speech service results received.

### RELATED APPLICATION

This application claims the benefit of U.S. Provisional Application No. 62/261,762, filed on Dec. 1, 2015. The entire teachings of the above application are incorporated herein by reference.

### BACKGROUND

Voice-enabled applications and services, such as provided in car infotainment system, typically include a dialog or user interface and can, for example, benefit from combining multiple results of independent Spoken Language Understanding (SLU) systems. There are known combination methods in the area of combining Automatic Speech Recognition (ASR) results, but these methods tend to suffer from missing timing information, missing unified phonetic descriptions, and processing latencies. SLU systems, including systems with combined information retrieval functionality, are denoted by speech services. Typically, each speech service is optimized for special domains, e.g., voice destination entry or voice command and control. Results of speech services are often overlapping. Combining speech services may introduce referential ambiguity as well as ambiguity in implication.

### SUMMARY OF THE INVENTION

A method of processing results from plural speech services includes receiving speech service results from plural speech services and service specifications corresponding to the speech service results. The results are at least one data structure representing information according to functionality of the speech services. The service specifications describe the data structure and its interpretation for each speech service. The method further includes encoding the speech service results into a unified conceptual knowledge representation of the results based on the service specifications and providing the unified conceptual knowledge representation to an application module.

The data structure can include at least one of a list of recognized sentences, a list of tagged word sequences, and a list of key-value pairs. The data structure can represent weighted information for at least a portion of the results. The data structure can further include at least one of an array or a tree storing information hierarchically.

The unified conceptual knowledge representation can be considered unified in that identical information is presented in an identical manner and can be considered conceptual in that related facts are defined in groups using a suitable representation. The unified conceptual knowledge representation can represent knowledge in a structured representation of information and can further provide an interface to connect with the application module.

The unified conceptual knowledge representation can include a list of concepts, each concept realizing a set of functions. A function call to one of the set of functions can return a result list. For example, a concept can contain a set of functions that define relations. and “realizing” can mean defining the relations based on the results. Consider, for example, the concept “destination entry,” which can describe the relations that are useful and that may be required for destination entry, e.g., the relations between street and city and house number. A function enables access to the relations, e.g., to get all house numbers in a given city or get a list of all cities with a similar pronunciation etc.

Encoding the speech service results can include applying a set of operators to the speech service results according to the concepts. Each concept may be factorized in a sequence of independent and general operators, the operators having access to shared resources. As a rule of thumb, all operators are independent and general. It is possible that some operators are specific or that some operators are dependent on others, but this is not preferred because it tends to reduce the re-usability of operators.

The sequence and selection of operators can be configured during run-time. Here, “run-time” refers to “after compilation,” so that one can change the sequence without re-compiling/building the software. Furthermore, configuration during run-time enables functional updates for an already deployed system simply by providing a new configuration (e.g., a new sequence definition).

Multiple concepts may be computed at a time, the multiple concepts receiving as inputs the same speech service results. The concepts can be semantic interpretations. Encoding the results can include computing a set of semantic groups given a set of speech service results from the plural speech services, each semantic group defined by identifying comparable data, the data being comparable when the data itself is similar given a distance measure or if the data shares relations to comparable data.

The application module can be a dialog module, a user interface, or the like, and can also be a priority encoder. For example, one priority encoder can encode the speech service results and provide results, represented in the unified conceptual knowledge base, to an application module that is another priority encoder. Cascading priority encoders in such an arrangement can facilitate merging of speech service results.

The speech services can be independent from each other. Each speech service can receive a common speech input, e.g., an audio signal, and generate an individual speech service result.

A system for processing results from plural speech services includes an input module, a priority encoder and an output module. The input module is configured to receive speech service results from plural speech services and service specifications corresponding to the speech services, the results being at least one data structure representing information according to functionality of the speech services, the service specifications describing the data structure and its interpretation for each speech service. The priority encoder can be configured to encode the speech service results into a unified conceptual knowledge representation of the results based on the service specifications. The output module is configured to provide the unified conceptual knowledge representation to an application module.

A computer program product includes a non-transitory computer readable medium storing instructions for performing a method for processing results from plural speech services. The instructions, when executed by a processor, cause the processor to be enabled to receive speech service results from plural speech services and service specifications corresponding to the speech services, the results being at least one data structure representing information according to functionality of the speech services, the service specifications describing the data structure and its interpretation for each speech service. The instructions, when executed by the processor, further cause the processor to encode the speech service results into a unified conceptual knowledge representation of the results based on the service specifications and provide the unified conceptual knowledge representation to an application module.

A method for handling results received asynchronously from plural speech services includes assessing speech service results received asynchronously from plural speech services to determine, based on a reliability measure, whether there is a reliable result among the speech service results received. If there is a reliable result, the reliable result is provided to an application module; otherwise, the method continues to assess the speech service results received.

The method for handling results can further include the process of representing the speech service results in a unified conceptual knowledge base. Assessing the speech service results can include determining, for each concept of the unified conceptual knowledge base, whether the knowledge represented by the concept is reliable for a given concept query of the application module.

The unified conceptual knowledge base can be an instance of an ontology, and the reliability measure can be indicative of how well a given speech service is able to instantiate the instance. The ontology can be a set of possible semantic concepts along with possible relations among the concepts. The ontology can be configured based on at least one of a speech service specification and speech service routing information.

The method can further include constructing the instance iteratively based on the speech service results received from the speech services, and can include selecting the reliability measure based on domain overlap between the speech service results.

For example, if there is no domain overlap between the speech service results, any one of the results can be considered reliable if (i) all the information that is expected to be represented based on the concept query is represented in the conceptual knowledge base and (ii) no other speech service can contribute a reliable result.

Alternatively or in addition, if there is full domain overlap between the speech service results, an error expectation of each speech service can be estimated, and the reliable result is determined based on evaluation of the error expectation.

The error expectation can be estimated from at least one of field data and user data relating to the speech services. Alternatively or in addition, the error expectation is estimated based on a signal-to-noise ratio (e.g., speech-to-noise ratio) or a classifier.

The method can include prioritizing speech service results from speech services with low error expectation. The method can further include automatically determining whether a combination of speech service results from speech services with high error expectation is sufficiently reliably or whether there is a need to wait for results from additional speech services. In general, the error expectation can be quantified as “low” or “high” relative to the other engines (speech services) as measured on some representative data. For example, one can define P_l(low_error)+P_h(high_error)=1. P_l and P_h can be used to rescale the result-probabilities of a recognizer “l” with a low error expectation and a recognizer “h” with higher error expectation. Hence, one result is boosted. The probabilities are trained on some representative data.

If there is partial domain overlap between the speech service results, the partial domain overlap can be handled as a case of full domain overlap if the overlap can be determined given the concept query, otherwise as a case of no domain overlap. In a particular example, this means that the query either falls into the overlapping or the non-overlapping part of the speech service. Further, although speech services can be partially overlapping, their results can either fully overlap or not at all.

A system for handling results received asynchronously from plural speech services includes an assessment module and an output module. The assessment module is configured to assess speech service results received asynchronously from plural speech services to determine, based on a reliability measure, whether there is a reliable result among the speech service results received. The output module is configured to provide, if there is a reliable result, the reliable result to an application module.

The system can include an encoder to represent the speech service results in a unified conceptual knowledge base. The assessment module can be configured to assess the speech service results by determining, for each concept of the unified conceptual knowledge base, whether the knowledge represented by the concept is reliable for a given concept query of the application module.

A computer program product includes a non-transitory computer readable medium storing instructions for handling results received asynchronously from plural speech services, the instructions, when executed by a processor, cause the processor to assess speech service results received asynchronously from plural speech services to determine, based on a reliability measure, whether there is a reliable result among the speech service results received. If there is a reliable result, the instructions cause the processor to provide the reliable result to an application module. Otherwise, the instructions cause the processor to continue to assess the results received.

Embodiments of the invention have several advantages. Novel method and systems for processing a plurality of speech services are described. Each speech service understands natural language given a semantic domain, e.g., voice media search or voice dialing. The speech services are designed, developed and employed independently from each other as well as independently from succeeding speech dialogs. Embodiments compute a unified conceptual representation from all hypotheses recognized from any speech services given a unified concept. Previous solutions are based on a decision between services. The decision in previous solutions is based on heuristic rules requiring information about speech services themselves. Hence, the speech dialog needs deep knowledge about the queried speech services. Each service addresses one domain and the dialog system takes care that only unique domains are active at the same time. In comparison to the previous solutions, the novel techniques disclosed herein benefit from speech services with overlapping domains.

In embodiments of the invention, no expert knowledge of speech services is required to create dialog flows. The decision whether to activate a specific speech service is a question of available resources, e.g., the available computational power, the available network bandwidth or also legal restrictions. Legal restrictions can include, for example, restrictions on accessing speech servers outside of a region/country and no use of wireless internet, e.g. in plains. Restrictions may also be context-dependent. For example, medical data should be kept on the device. The techniques described herein represent an abstraction layer between automatic speech understanding and the dialog system.

Embodiments of the inventions may process results from plural speech services in two stages: an encoding stage and a prioritization stage. The encoding stage encodes and collects results into the unified conceptual knowledge base. The prioritization stage handles asynchronously-received results and makes a decision as to which results are delivered to an application, e.g., a dialog, in response to a query.

Considering results from speech services as instances of an unknown information source is useful. Also, composing uncertain instances into one conceptual representation is useful for any applications in the area of speech or natural language processing.

Embodiments do not only decide whether to use results from one or the other speech service, but also combine and derive a unified result representation. Embodiments implicitly use the domain overlap of speech services to boost certain results, e.g., those which are confirmed by various speech services. This can be seen as a generalization of the cross-domain validation method. This method was previously implemented by a dialog system for dedicated domains. Embodiments disclosed herein enable an inter- and intra-domain validation of speech entities, e.g., a city name was spoken in the context of a music title. The technique also enables a conceptual representation across speech services. For example, the conceptual knowledge can be partly given by a plurality of speech services. This enables the introduction new functionality without the need to modify speech services.

The priority encoder applies a set of reusable and configurable operators on results from an arbitrary number of speech services. This modular implementation enables a fast and flexible deployment on reliable operators.

There are several advantages compared to previous approaches. Embodiments decouple speech services from the dialog flow. In conventional approaches, the dialog controls explicitly all speech services. There, the dialog starts and stops the processing and decides which results are used for further processing. This dialog flow is designed by human experts, which can be costly to design and may not achieve the overall best performance because of the need for pre-defined thresholds. The new technique described herein uses user behavior and knowledge about expected error behaviors of speech services to achieve the best accuracy with a minimal latency. Both user behavior and expected error behavior of speech services are estimated continuously. The technique can also consider environmental circumstances, such as a current noise level, to assess results.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram illustrating an example dialog system in which an embodiment of the invention can be deployed.

FIG. 2 is a block diagram of a method and system for processing results from speech services, to serve as input for another application module, such as a dialog engine.

FIG. 3 is a block diagram illustrating an example deployment of plural speech services and plural priority encoders.

FIG. 4 is an example graph representing conceptual knowledge.

FIG. 5 is a block diagram illustrating factorization of concepts in a sequence of operators.

FIG. 6 is a graph illustrating association of data and semantic groups using an example distance measure based on syntactical features.

FIG. 7 is a graph illustrating an example distance measure based on canonical features.

FIG. 8 is a graph illustrating an example distance measure based on phonetic information.

FIG. 9 is a graph illustrating example use of prior knowledge to strengthen (e.g., boost) data.

FIG. 10 is a schematic diagram illustrating an example set of semantic groups for information gathered for speech services.

FIG. 11 is a timing diagram illustrating an example dialog flow for handling results from multiple speech services.

FIG. 12 is a block diagram illustrating an example system for handling results received from plural speech services.

FIG. 13 is a flow diagram illustrating an example method for handling results received from plural speech services.

FIG. 14 is a schematic diagram illustrating an example use case of no domain overlap between the results from two speech services.

FIG. 15 is a schematic diagram illustrating another example use case of no domain overlap between the results from two speech services, each speech service contributing to both domains.

FIG. 16 is a timing diagram illustrating an example case of a successful concept query.

FIG. 17 is a schematic diagram illustrating a graphical representation of a use case given a full domain overlap between results from speech services.

FIG. 18 is a timing diagram illustrating an example decision process that includes waiting for results from all speech services.

FIG. 19 is a schematic diagram illustrating an example use case of partial domain overlap between results of speech services.

FIG. 20 is a timing diagram illustrating timing of an example decision process for two concepts.

FIG. 21 is a network diagram illustrating a computer network or similar digital processing environment in which embodiments of the present invention may be implemented.

FIG. 22 is a diagram of an example internal structure of a computer (e.g., client processor/device or server computers) in the computer system of FIG. 21.

### DETAILED DESCRIPTION OF THE INVENTION

A description of example embodiments of the invention follows.

Embodiments of the invention solve the problem of combining multiple results of independent Spoken Language Understanding (SLU) systems. Known combination methods from the area of combining Automatic Speech Recognition (ASR) results are not applicable because of missing timing information, missing unified phonetic descriptions and latency requirements. Embodiments can consider the combination of results from any SLU systems including systems with combined information retrieval functionality. Such systems are denoted by speech services.

An example speech service that can be employed with embodiments of the inventions is NUANCE® Cloud Services (NCS), a platform that provides connected speech recognition services using artificial intelligence, voice biometrics, contextual dialogue, content delivery, and chat technologies. For a description of NCS web services, see, e.g., “NUANCE® Cloud Services, HTTP Services 1.0 Programmer's Guide,” Nuance Communications, Inc., Dec. 4, 2013.

Another example speech service that can be used is a Finite State Transducer (FST). An FST is described, for example, in International Application No. PCT/US2011/052544, entitled “Efficient Incremental Modification of Optimized Finite-State Transducers (FSTs) for Use in Speech Applications,” published as International Publication Number WO 2013/043165.

Another example speech service that can be used is a Fuzzy Matcher (FM). A phonetic fuzzy matcher is described, for example, in U.S. Pat. No. 7,634,409, entitled “Dynamic Speech Sharpening,” issued on Dec. 15, 2009.

Section 1: Representing Results From Various Speech Services As A Unified Conceptual Knowledge Base

Deriving unified conceptual knowledge from a plurality of speech services is a challenge. An example embodiment processes a plurality of speech services to provide a unified conceptual representation to succeeding modules, e.g., dialog systems. Any dialog system typically requires a unified representation of conceptual knowledge to conduct humanoid dialogs.

Current solutions exist, where a dialog system may introduce dedicated states to avoid ambiguity on the one hand, e.g., voice destination entry is only available in a navigation dialog state. On the other hand, a dialog system may reduce the functionality of speech services in dialog state where ambiguity has to be expected, e.g., on a main or top-level menu. Hence, the dialog is influenced by expert knowledge over speech services. Embodiments may avoid any dependencies to speech services during dialog development. This is a useful benefit given the large amount of different speech services.

Today, ranking methods are used to combine the growing popularity of a simultaneous use of competitive recognizers. The comparability of results itself is often not questioned and based on independently trained confidence measures. In contrast, embodiments use the overlapping and ambiguous information of arbitrary speech service to increase the overall accuracy. It computes a unified conceptual representation. Succeeding dialog modules are decoupled from the plurality of speech services.

The underlying linguistic and mathematical framework of embodiments of the present invention may be related to common knowledge representations such as topic or concept maps. The novel method described herein differs since it processes sub-set instances of information sources and not a fully explored information source. In addition, all sub-set instances are weighted given the uncertain nature of speech recognition.

A benefit of example embodiments becomes apparent when a plurality of speech services is used to serve one succeeding module, e.g., a dialog system. Such embodiments compete with speech systems following an integral product design where the problem of combining multiple results from independent speech services does not occur due to a unified model-training that entails a loss of modularization and customization. Embodiments can complete the modular product design of speech systems, such as the speech systems from Nuance Communications, Inc.

Embodiments of the present approach offer commercial advantages. Embodiments can be a useful part of various automotive deliveries of content and natural language understanding technologies. The modular design of the speech service can be a differentiating factor. Ab example embodiment can be implemented in a dedicated module in a voice and content delivery platform, e.g., in the NUANCE® Dragon Drive Framework. The module, denoted herein as a ‘priority encoder,’ completes the Framework with advanced hybrid speech functionalities and it is a consecutive step following the pluggable apps concept of the NUANCE Dragon Drive Framework. The priority encoder provides a unified result from independent speech services. The priority encoder decouples the dialog development and enables a more efficient developing process for hybrid speech use-cases. As used herein, “hybrid” refers to a set-up where local and connected speech solutions are involved. Embodiments can have a significant market value. Processing results from a plurality of independent speech services is a unique selling point. Embodiments enable new applications and more flexibility for customers (e.g., users) and, at the same time, allows the technology provider to increase the process efficiency to serve new customers.

A dialog system, e.g., a dialog of a car head-unit, is typically aimed at providing a uniform look and feel to a plurality of applications. An application can be the air condition system of the car, or the car's navigation, multimedia, or communication systems. The dialog has methodological knowledge of each application. It knows the behavior of each application and knows how to interact with each of them. The input of any dialog system is conceptual information, e.g., the status of a button which is labeled with ‘next’, ‘mute’ or ‘up.’ This information can be used together with hypothesis of a speech understanding module to conduct a humanoid dialog. Most common dialog systems use a multimodal user interface. Such a user interface includes not only haptic interfaces but also gestures, bionics and speech.

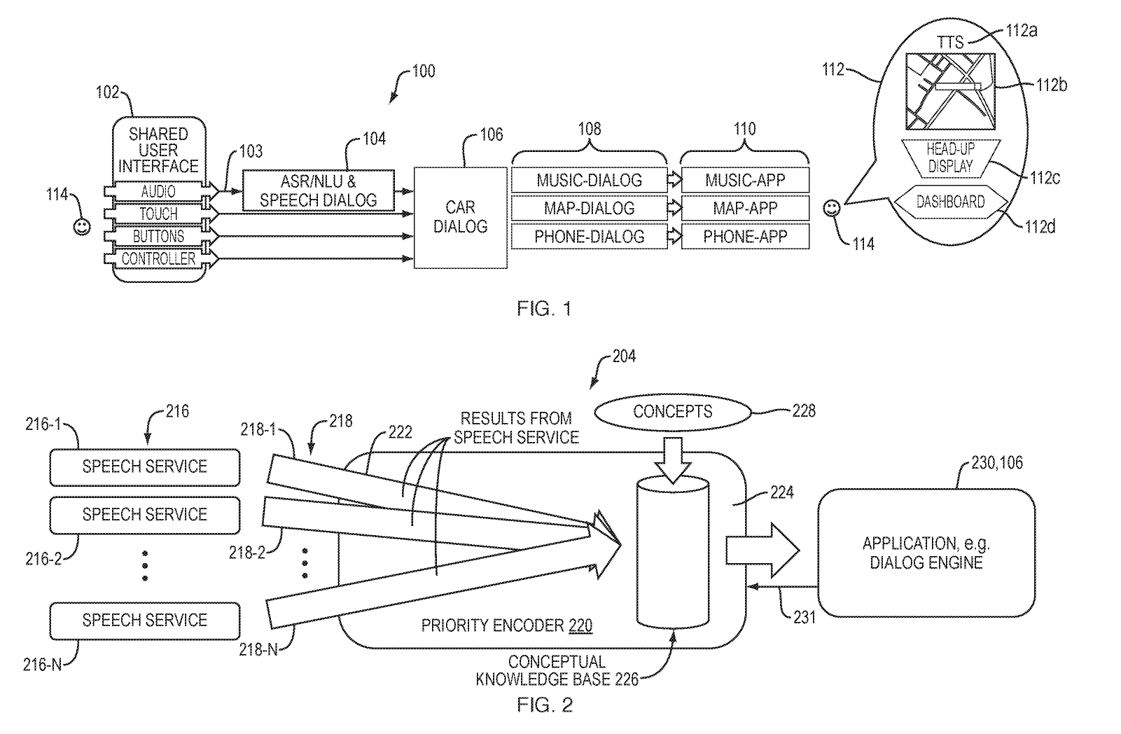

FIG. 1 is a block diagram illustrating an example dialog system 100 in which an embodiment of the invention can be deployed. A user interface 102 receives input, e.g., a query or command, from user 114. The user interface can be shared among different systems and among different application. As shown, the user interface 102 is multimodal, including audio (speech), haptic (touch), buttons, and a controller. An audio signal 103 is provided as an input to a system 104, which processes the audio signal 103 via ASR and NLU and which can include a speech dialog. The output of system 104 is provided to a car dialog 106. The shared user interface 102 may provide the input from touch, buttons and controller directly provided to the car dialog. The car dialog 106 provides the user input information to the various applications 110 (e.g., Music-App, Map-App, Phone-App) via application specific dialogs 108 (e.g., Music-Dialog, Map-Dialog, Phone-Dialog). The car dialog can ensure correct mapping of user input to the applications. For example, the car dialog may ensure that the button pressed by the user is a volume button that is mapped to the music-dialog, which makes the information available to the music application. The result of the user's query or command can be presented to the user via a user interaction, as illustrate at 112. The user interaction can be through a text-to-speech (TTS) interface 112a, a map 112b, a head-up display 112c, a dashboard interface 112d, and the like.

A useful technique is described for the processing of various speech services, and their respective results, to serve as input(s) for other application(s), e.g., as input(s) for one or more dialog systems. A speech service processes speech or languages, e.g., the speech service recognizes and understands spoken languages. A speech service may also be a data base look-up, e.g., to derive music titles or geo-locations. Embodiments of the invention comprise a technique that computes a unified conceptual representation of an arbitrary number of results from various speech services. This enables the development of a decoupled dialog system because the dialog can be designed on top of unified concepts.

FIG. 2 is a block diagram of a method and system 204 for processing results from speech services, to serve as input for an application module 230, such as a dialog engine or the car dialog 106 (FIG. 1). Plural speech services, 216-1, 216-2 and 216-N (collectively 216), process at least one common input, e.g., an audio signal, to produce plural speech service results, 218-1, 218-2, 218-N (collectively 218). There can be N number of speech services 216 producing respective N number of results 218. The speech services can share a common audio (speech) input, such as audio signal 103 (FIG. 1). The system 204 can include an input module 222, a priority encoder 220 and an output module 224. The input module 222 is configured to receive speech service results 218 from plural speech services 216 and one or more service specifications corresponding to the speech services. The service specification(s) can be received as part of the results 218 or as separate inputs (not shown). The speech service results 218 can be provided in at least one data structure. The data structure can represent information according to functionality of the speech service(s). The service specification(s) can describe the data structure and its interpretation for each speech service.

The priority encoder 220 encodes the speech service results 218 into a unified conceptual knowledge representation (knowledge base) 226 based on the service specifications. The output module 224 provides the unified conceptual knowledge representation 226 to an application module 230. The application module 230 can be a speech dialog, a car dialog, or the like. The application module 230 can pass a query 231 to the priority encoder 220 to query the conceptual knowledge base 226.

Embodiments described herein can be realized in a module called ‘priority encoder’ for speech services. The priority encoder can process results from an arbitrary number of speech services and computes a unified conceptual knowledge base. The knowledge base can be defined by a set of concepts 228 and can be queried (231) by a set of concept dependent functions. The results from speech services are combined, as illustrated in FIG. 2. The ambiguity within and between speech services is resolved to the greatest possible extent. The priority encoder, e.g. its output, is used by other, e.g., proceeding, modules, including speech dialogs, such as dialog 230 and car dialog 106.

Speech services can be independent from each other. Typically, all speech services receive at least a common input (e.g., an audio signal) and each speech service produces an output (e.g., a result or a set of results).

An example embodiment can be deployed as a dedicated module, denoted as “priority encoder.” The input of the priority encoder is a set of results from various speech services as well as a service description. The output is a unified conceptual representation of any results generated by the speech services. A speech service can be hosted in the cloud or somewhere on a device. Also, the priority encoder is applicable to and can be deployed on a server infrastructure or on an embedded device. This enables decentralized software architecture, which can be adapted to the available infrastructure.

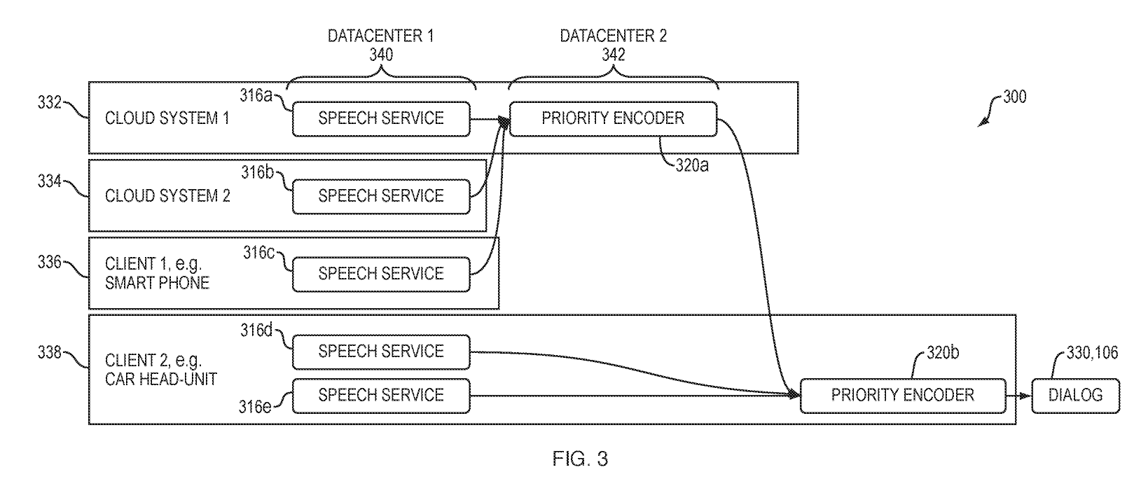

FIG. 3 is a block diagram illustrating an example deployment of plural speech services (316a, 316b, 316c, 316d, and 316e) and plural priority encoders (320a, 320b) in a system 300. Speech services 316a and 316b are hosted in first and second cloud systems 332 and 334, respectively. The cloud system 332 also hosts priority encoder 320a, albeit in a separate datacenter 342 from datacenter 340 in which the speech service 316a is hosted. Speech service 316c and speech services 316d and 316e are hosted on first and second clients 336 and 338, respectively. In the example, client 336 is a smart phone or other mobile device and client 338 is a car head-unit. The client 338 also hosts a priority encoder 320b, which receives as input(s) not only results from speech services 316d and 316e but also from the priority encoder 320a. The priority encoder 320b interfaces with, e.g., provides a result to, a dialog 330. The dialog, in one example, can be the car dialog 106 of FIG. 1.

As shown in FIG. 3, the priority recorder 320b provides a merged result, e.g., a result combined from the results of the speech services and from the output of another priority encoder.

In the following is an interface definition for the input and output of an example embodiment of the priority encoder.

Input of the priority encoder:
a) Results from speech services: A data structure representing information given the speech service functionality. This could be a list of recognized sentences, a tagged word sequences or key-value pairs. Parts of the result could be weighted. Typical data structures are arrays and trees storing information hierarchical.
b) Service specification: Describes the data structure and its interpretation for each speech service.

Output of the priority encoder:
a) Unified conceptual knowledge representation: Unified refers to the principle that identical information is represented identical. Conceptual refers to the principle of defining related facts in groups using a suited representation. Knowledge refers to a structured representation of information. Representation refers to an interface with which a succeeding module is connected. Technically, the output is organized as a list of concepts with each concept realizing a set of functions. The result of a function call is once again a list.

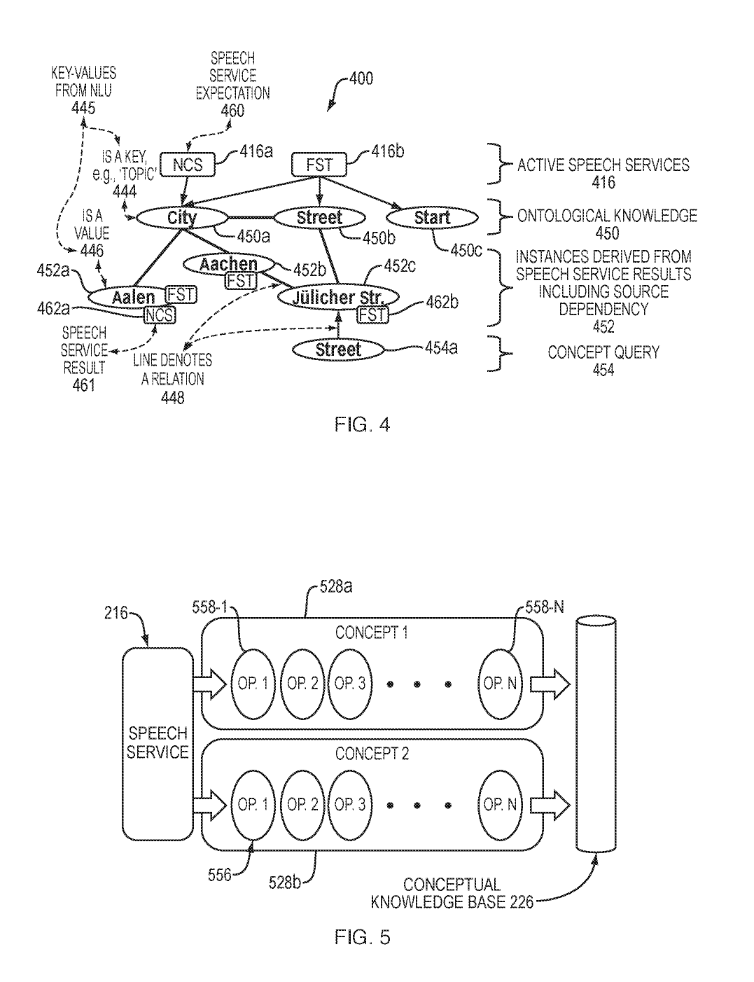

The priority encoder defines conceptual knowledge and gathers information from all speech services to serve concepts. The knowledge can be represented as a graph, although the graph is not necessarily used for the concrete implementation. An example graph is given in FIG. 4.

FIG. 4 is an example graph 400 representing conceptual knowledge. The graph shows information at different levels (e.g., in a hierarchical tree structure). As indicated at 448, each line denotes a relation between elements (e.g., nodes) of the graph 400. The relations (also referred to herein as transitions) between elements can be weighted, the weighting being, for example, according to measurements, priors, reliability, etc. At the level of active speech services 416, two speech services 416a (“NCS”) and 416b (“FST) are shown. In this and the following figures, “NCS” and “FST” are used as representative examples of speech services. It will be understood that any type of speech service may be employed, including those described in this disclosure, and that the particular examples shown are non-limiting examples. Each speech service can be associated with a speech service expectation, as illustrated at 460. This can be an error expectation, as further described herein. At level 450, which represents ontological knowledge, three keys (e.g., topics) 444 are shown: “City” 450a, “Street” 450b and “Start” 450c. As shown, speech service 416b (“FST”) is associated with (e.g., can produce results for) all three keys shown, but speech service 416a (“NCS”) is only associated with the key “City” 450a. Further, keys 450a and 450b are associated to each other, as they both relate to an address, but are not associated with key 450c, which relates to a command. At level 452, which includes instances derived from speech service results, including source dependency, the graph 400 has three elements: two city names, “Aalen” at 452a and “Aachen” at 452b, and one street name, “Jülicher Str.” at 452c. The city and street names are values 446, which are associated with keys 444, as denoted by lines. Key-value combinations 445 are received from Natural Language Understanding (NLU). Indicators 462a and 462b show the source of a particular result 461, e.g., which of the speech services 416a and 416b contributed the results. In the example shown in FIG. 4, one concept query 454a (“Street”) is shown for the Concept Query level 454.

In FIG. 4, a speech input for the example shown may be “Aachen Jülicher Str.” and the concept query from a dialog may be to get a list of streets. As shown, “Aachen” is tagged as a city and “Jülicher Str.” is tagged as a street and also identified as related to the city “Aachen,” that is, it is identified as a street in that city. Thus, for concept query 454a (“Street”) there is a result 452c (“Jülicher Str.”) in the unified conceptual knowledge base, which can be provided as a result to an application module, e.g., the dialog. If the concept query were for a command, such as “Start,” the result of the query would be empty as no values are shown associated with the key 450c (“Start”).

On the input side, e.g., what the speech services deliver via the unified conceptual knowledge base, are concepts. On the application side, a dialog or user-interface also has concepts. Embodiments decouple input level concepts from application concepts. This facilitates developing of new applications that can interface with speech services. From a software perspective, there is a mapping of application side concepts to input side concepts. The mapping can be provided at run-time.

The priority encoder resolves ambiguity and delivers a unified result given a concept. A concept defines a set of functions. In the following is an example concept definition for address entry:

Get a list of <city> or <street> or (<street> and <city> combinations)

Get a list of <cities>

Get a list of <streets>

Get a list of <street> and <city> combinations>

Get a list of city confusions, e.g. on acoustical similarity

Get a list of tokenized streets

A similar concept can be defined for music search:

Get a list of <Artist> or <Title> or (<Artist> and <Title> combinations)

Get a list of <Artists>

Get a list of <Titles>

Get a list of similar Titles, e.g., on syntactical similarities

The concept definition is specified, e.g., by the customer, and serves as input for succeeding modules. Concepts can differ from each other given the natural variation of concepts. For example, a concept for voice dialing can differ significantly from one for voice memos. One may desire to keep the number of concepts small even though there is no technical reason for any limitations. A concept can be factorized in a sequence of independent and general operators. All operators have access to shared resources. An example of a shared resource is a tree based data structure to which each operator can read and write, but from which usually no operator can delete. The shared resources can, for example, be deleted by the start of a speech reset. The sequence and selection of operators can be configurable during run-time, which provides flexibility. Multiple concepts can be computed at a time given the same set of speech services as input.

FIG. 5 is a block diagram illustrating factorization of concepts in a sequence of operators. Operators 558-1 to 558-N (“Op. 1” to “Op. N”) process results from one or more speech services 216. Shown are two concepts 528a and 528b. For each concept, there can be a sequence 556 of operators. The functionality of the concept is factorized into the sequence of operators. The output of the sequence of operators is provided to the conceptual knowledge base 226.

An example operator sequence for an example concept is as follows.

1. Operator: Tokenize

2. Operator: Abbreviation handling

3. Operator: Phrasing

4. Operator: Merge identical entities

5. Operator: Add C-City for all nodes marked by City or Town

6. Operator: Add C-Street for all nodes marked by Street

7. Operator: Add C-Navigation based on the existence of C-City|C-Street

In the above, C-City, C-Street and C-Navigation are unified tags that are added to results, e.g., nodes, in a graphical representation of the conceptual knowledge base. One goal of the above example sequence is to add knowledge to the results from the speech services by combining results, for example, based on a similarity measure. For example, operators 5, 6 and 7 in the above example sequence add unifying tags to the results. City and town are similar, so operator 5 tags them C-City. If tags C-City and C-Street are together, add a navigational tag C-Navigation. This represents a 2:1 mapping, which is an example of, adding knowledge to the results.

The priority encoder can comprise a set of operators and a configurable processing platform of operators using some shared resources. The priority encoder can comprise a set of factorizations for a set of concepts, as illustrated, for example, in FIG. 5.

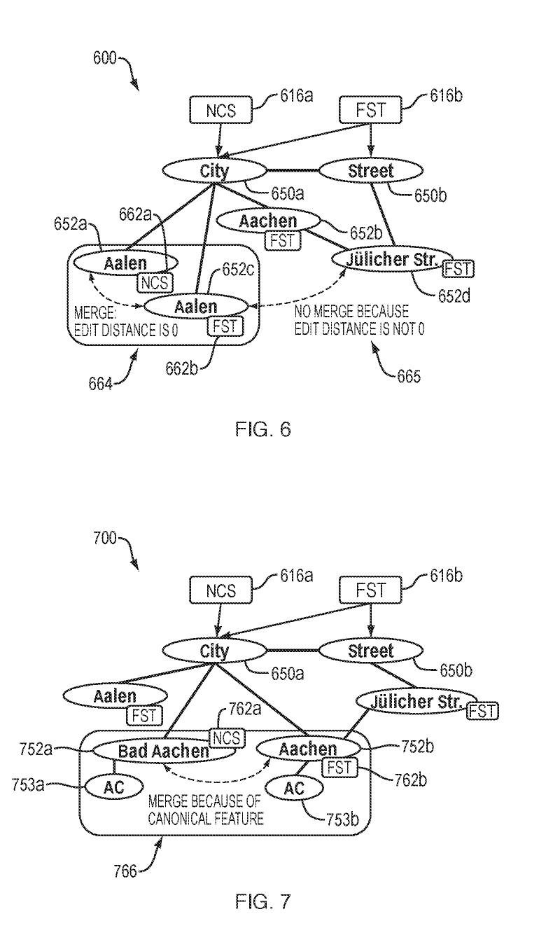

An abstract view on concept computation is summarized in the following: A set of operators computing a set of semantic groups given a set or results from a plurality of speech services. A semantic group is defined by identifying comparable data. Data is comparable when the data itself is similar given a distance measure or if data shares relations to comparable data. The distance measure and the relation are given by a numerical value and they are intended to represent probabilities. The association of data in semantic groups resolves syntactical and referential ambiguity. The distance between data structures is based on a syntactical comparison of entities between both data structures, e.g., using an edit distance as illustrated in FIG. 6.

FIG. 6 is a graph 600 illustrating association of data and semantic groups using an example distance measure based on syntactical features. The elements of the graph (e.g., nodes) and the relations among the elements (e.g., connecting lines) are similar to graph 400 described above with reference to FIG. 4. As shown in FIG. 6, there are two speech services 616a and 616b, two associated keys 650a (“City”) and 650b (“Street”), and values 652a, 652b, 652c, and 652d associated with the keys (key-value pairs). The figure illustrates merging of results based on an edit distance. In the example shown, the edit distance is based on a letter-by-letter comparison of the text. If the letters are the same, the edit distance is 0. As indicated at 664, values 652a (“Aalen”) and 652c (“Aalen”) are merged as they have an identical sequence of letters, and the calculated edit distance is 0. The two values 652a and 652c are results from two different speech services 616a (“NCS”) and 616b (“FST”), as indicated by source identifiers 662a and 662b, respectively. As indicated at 665, value 652d (“Jülicher Str.”) is not merged with value 652c, as the edit distance is not 0.

The distance measure is not limited to syntactical features. Distance measures based on canonical features or on phonetics can also be use. Expert knowledge can be used according to the speech service specification, e.g., to unify canonical features across speech services.

FIG. 7 is a graph 700 illustrating an example distance measure based on canonical features. Here, values 752a (“Bad Aachen”) and 752b (“Aachen”), both associated with key 650a (“City”) are merged because of a canonical feature as indicated at 766. This is so because both values are associated with the same canonical feature (“AC”) as indicated at 753a and 753b. In the example, the canonical feature is the two letter symbol “AC” used on license plates to denote the city. Note that the value 752a resulted from speech source 616a, as indicated by source identifier 762a, and that the value 752b resulted from speech service 616b, as indicated by source identifier 762b.

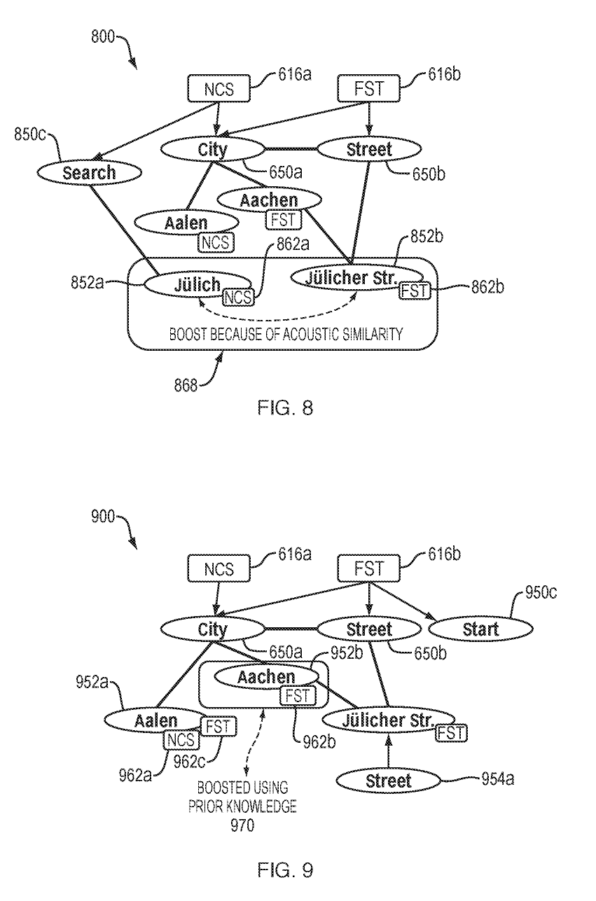

FIG. 8 is a graph 800 illustrating an example distance measure based on phonetic information. Phonetic information and result quality measures can be provided by preceding speech services or other acoustic similarity measures. In FIG. 8, results 852a (“Jülich”) and 852b (“Jülicher Str.”) are strengthened (e.g., boosted) because of acoustic similarity, as indicated at 868. The two results are results that cannot be merged, but the process assigns increased probability to each. The values 852a and 852b are results from speech services 616a and 616b, respectively, as indicated by source indicators 862a and 862b. In the example, the value 852a is associated with key 850c (“Search”) and the value 852b is associated with key 650b (“Street”), but the two keys share no direct association.

Prior knowledge can be used to strengthen data, e.g., caused by the distribution of the used training data to estimate the classification models from some speech services.

FIG. 9 is a graph 900 illustrating example use of prior knowledge to strengthen (e.g., boost) data. Here, value 952b (“Aachen”) from speech service 616b (“FST”) is boosted because of prior knowledge, as indicated at 970. The boost can be applied, for example, because of knowledge that the source (“FST”), indicated by source identifier 962b, is more reliable on cities, e.g., key 650a (“City”), than on other keys. The value 952b may also be boosted because an application, e.g., a dialog, expects such a city. For example, the query 954a (“Street”) may include the expectation from the dialog that the street is in a particular city, e.g., the city “Aachen.” In the example shown, the value 952a (“Aalen”) was received as a result from speech service 616a (“NCS”), as indicated at 962a, and also from speech service 616b (“FST”), as indicated at 962c. However, no boost using prior knowledge is applied to value 952a. Similar to the example illustrated in FIG. 4, a concept query for “Start” in the example of FIG. 9 would return an empty result, as there is no value associated with key 950c (“Start”) in graph 900.

The feature computation happens by a set of operators and is part of the concept factorization. The factorization is done by human experts. A data structure has relations to other data structures, e.g., an instance is related to a class. For example, <city>is a class and “Aachen” is an instance of this class. It is intended to compute inter- and intra-relations of speech service results. This process resolves word sense ambiguity in two aspects. First, ambiguity becomes visible. Second, the relation to other data measures the degree of ambiguity. Ambiguity can become visible through results from different speech services. Then, a distance measure can be used to quantify the ambiguity. For example, consider an address-service result “New York” and a shopping-service result “New Yorker.” The system will boost “new” as correct and also the likelihood for “York” and “Yorker” will increase. This will increase the recognition accuracy, because the user probably said something like “new” and “York” or “Yorker.” Ambiguity can be measured using a distance measure, as “York” equals “Yorker” by a distance of 2, based, for example, on the edit distanc measure. The feature computation has a significant impact on the arising of relations. The result is a set of semantic groups comprising all information gathered from all speech services.

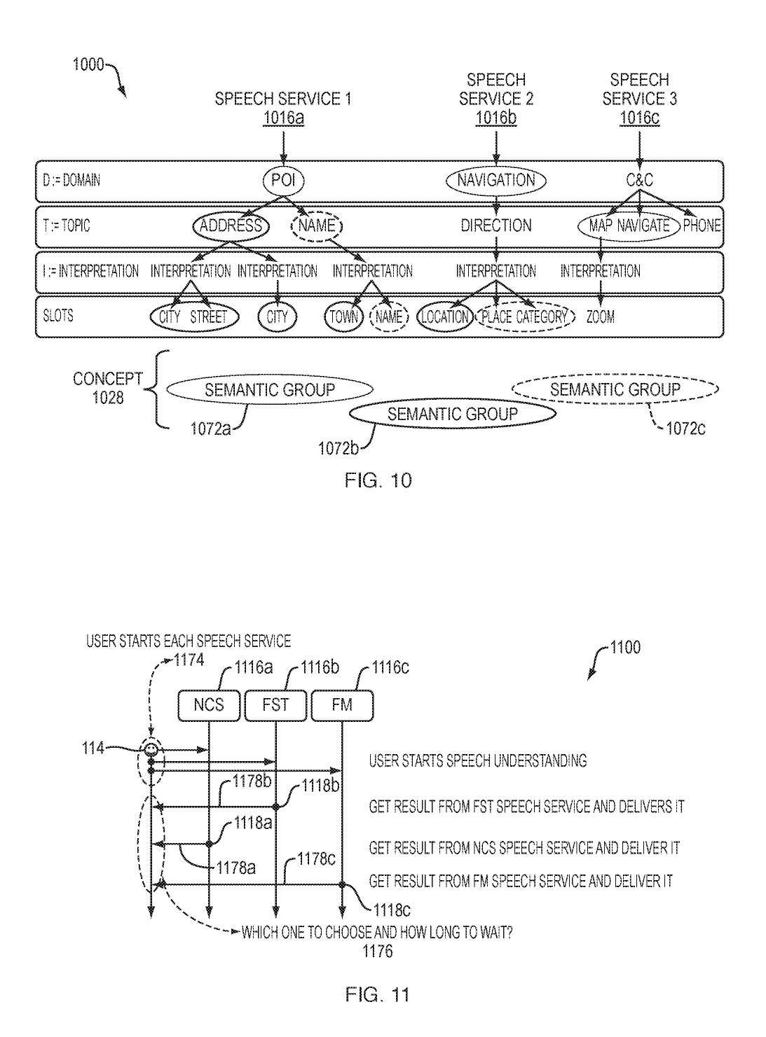

FIG. 10 is a schematic diagram 1000 illustrating an example set of semantic groups 1072a, 1072b, and 1072c for information gathered for speech services 1016a, 1016b, and 1016c. A concept 1028 is distributed across the semantic groups. The information is arranged in a tree-based structure according to multiple hierarchical levels, including Domain (D), Topic (T), Interpretation (I) and Slots of results. A particular speech service may only provide results for certain levels. For example, the semantic group 1072a may only apply to levels D and T, e.g., to Point of Interest (POI) and Navigation in level D, and Map and Navigate in level T.

The diagram 1000 of FIG. 10 indicates an example data structure that can be used in embodiments of the invention. Speech service results may be encoded in a unified conceptual knowledge representation according to this data structure. A service specification may guide the encoding process, for example, by specifying elements, connections, and hierarchical levels etc. of the data structure according to a particular speech service.

A sequence of operators is evaluating the set of semantic groups given the definition of a concrete concept, e.g., the definition of an address entry concept or the concept definition for music. The concept comprises the evaluation of all defined functions in two stages. First, the set of semantic groups is queried given the function definition queries, e.g., look for a semantic group given a relation between street and city entities. Second, the quality of the query result is measured by calculating the distance and relation measurements, e.g., compute the joined probability of the street given the probability of all speech services which recognized the street phonetically similar. The quality of the concept is given by evaluating the query quality of all functions. Hence, it supports the resolving of ambiguity in implication. The result is a ranked list of concepts and each concept may provide a ranked list of results for each called function. The set of results is a unified conceptual representation of speech services and serves proceeding modules, e.g., a speech dialog. The speech dialog introduces methodological knowledge of how to interact with actors and defines the look and feel of the multimodal user interface. Altogether, such a user interface is capable of answering natural language formulated questions, e.g., ‘What is the oil level of the engine?’, and of following natural language formulated instructions, e.g., ‘Increase the temperature by 4 degrees.’

In the following is an example factorization into operators for the address entry concept:

Tokenize; e.g., tokenize “main street” to “main” and “street”

Abbreviation handling; e.g., convert “Street” to “Str.” and “Str.” to “Street”

Phrasing; e.g., combine “main” and “street” to “main street”

Merging; e.g., mere <City> and <Street> to <search-phrase>

Re-tag; e.g., map <CITY_NM> to <City> and <STREET_NM> to <STREET>

The priority encoder conceals the origin of results and combines these efficiently to achieve the best overall performance from a proceeding module point of view. The priority encoder introduces a clear abstraction layer between conceptual and methodological knowledge and enables a decoupled dialog design.

Section 2: Content Aware Interrupt Handling for Asynchronous Result Combination of Speech Services

Assessing results from a plurality of asynchronous speech services is a problem. Each speech service is specialized to serve different language domains, e.g., voice destination entry, music search or message dictation. Overlapping domains cannot be excluded. A speech service may also comprise information retrieval functionality. Some of the speech services are running on an embedded device, others are running as connected services, e.g., on the cloud. The latency between speech services may vary significantly.

It is desired to always achieve the overall best accuracy when processing results from plural speech services. On the other hand, waiting for all results is not applicable given the demand of a low latency. This disclosure describes a useful technique that solves this issue. The technique assesses results from speech services, asynchronously. This technique achieves the overall best accuracy with a minimal latency. It decouples succeeding modules from the speech services which for instance simplifies the dialog flow significantly.

FIG. 11 is a timing diagram 1100 illustrating an example dialog flow for handling results from multiple speech services. In this diagram, time progresses from top to bottom, as indicated by vertical arrows. Furthermore, in this and subsequent figures, “NCS,” “FST” and “FM” are used as representative examples of different speech services, it being understood that any suitable speech services may be employed.

As illustrated in FIG. 11, a user 114 starts speech understanding, e.g., by submitting a speech input, e.g., an audio signal, a gesture, etc., to speech services 1116a, 1116b and 1116c, as indicated at 1174. Any related information that may be needed to activate the speech services can be submitted with the speech signal or may be submitted separately. Speech services may be activated at approximately the same time, or, as illustrated in the figure, they may be activated sequentially. The speech services process the speech input, and any received information, and produce a result or set of result(s). As shown, a result 1118b from speech service 1116b (“FST”) is provided first. As shown at 1178b, the system, e.g., a processing module, retrieves the result from the speech service and delivers it to an application, e.g., a dialog or user interface and/or the user. Next, a result 1118a is received from speech service 1116a (“NCS”), and then a result 1118c from speech service 1116c (“FM”). The system gets these results and delivers them to the application and/or the user, as indicated at 1178a and 1178c. The application, e.g., the dialog or user interface, has to make a decision as to which of the results to choose, e.g., for presentation to the user, and how long to wait for results, as indicated at 1176.

Today, the result is typically taken from the very first speech service that provides a reasonable confidence. The decision rule is often represented in a dialog flow, such as the example illustrated in FIG. 11. Designing such dialog flows is increasingly complicated when the more speech services are used in parallel. A human expert typically needs to consider the advantage, disadvantage and latency behavior for each speech service. From a development perspective, this is expensive and not flexible enough to add new requirements, easily. An example embodiment assesses results asynchronously and makes a content dependent decision to achieve the best possible accuracy with a minimal latency.

An example embodiment makes the assessment of results based on a unified conceptual knowledge base (also referred to as a unified conceptual knowledge representation). This knowledge base comprises results from a plurality of speech services and is constructed iteratively. The construction of a conceptual knowledge base is stateless. It ensures a unified representation. The construction is described above in Section 1 entitled, “Representing results from various speech services as a unified conceptual knowledge base.” The technique described herein adds a timing dependency. It enables a decision as to whether the results given at some point in time are reliable or not. The dialog logic is fully decoupled from the decision process.

The proposed technique delivers the best possible accuracy with a minimal latency. It decouples the methodological dialog flow (e.g., actions to start playing music) from the timing behavior of speech services (e.g., start/end control of speech streaming and result handling of receiving multiple results from a plurality of speech services). This further simplifies the dialog flow. Embodiments of the present approach, however, can reduce the control opportunities of the dialog, but at the same time also reduce control complexity. This may have a significant impact on existing dialogs.

Described herein is a useful technique that decouples the dialog from speech services. In certain embodiments, the only thing that may be configured through the dialog is the conceptual domain. Note that even the conceptual domain may not directly correspond to a dedicated speech service but rather to a unified semantic representation. The unit that controls all speech services may use this information to query and distribute dedicated speech services. A plurality of speech services may contribute to the expected domain. All this knowledge is now decoupled from the dialog and can be optimized independently. The described technique decouples succeeding modules from speech service dependent knowledge to the greatest possible extent.

A current solution requires starting from scratch for each new configuration of speech services. This is becoming more and more problematic given the fact that the number of speech services used in parallel continuously increases. An example embodiment is built once and can be reused for many applications. Furthermore, it decouples the speech services from succeeding modules, e.g., dialogs or other interfaces. With the solution described here, the speech dialog is robust against changes in the speech front-end because embodiments are speech service agnostic. Thus, with embodiments of the current approach, there typically is no need to modify the speech dialog if the speech front-end changes. The dialog does not need to take care of data flow between speech services, but can build on reliable speech processing.

Embodiments according to the present invention have at least two commercial benefits. First, embodiments can reduce the cost for designing advanced dialogs. They can also reduce application maintenance cost over the application-product lifetime. Second, embodiments can provide a distinctive feature over competitive solutions. Embodiments can be implemented as an additional module in the NUANCE® Dragon Drive Framework. The technique fits into modular product design of speech services, such as Dragon Drive. The technique increases the functionality of the speech services framework and enables sophisticated speech applications. Achieving the best accuracy with a minimal latency can be a unique selling point. A similar performance can only be achieved with an inappropriate amount of resources and costs. Advantageously, an example embodiment does not require any additional configuration or expensive modelling of heuristic knowledge. Embodiments of the invention decouple succeeding modules, e.g., dialog module(s) from speech services. This simplifies the processing of speech and language results.

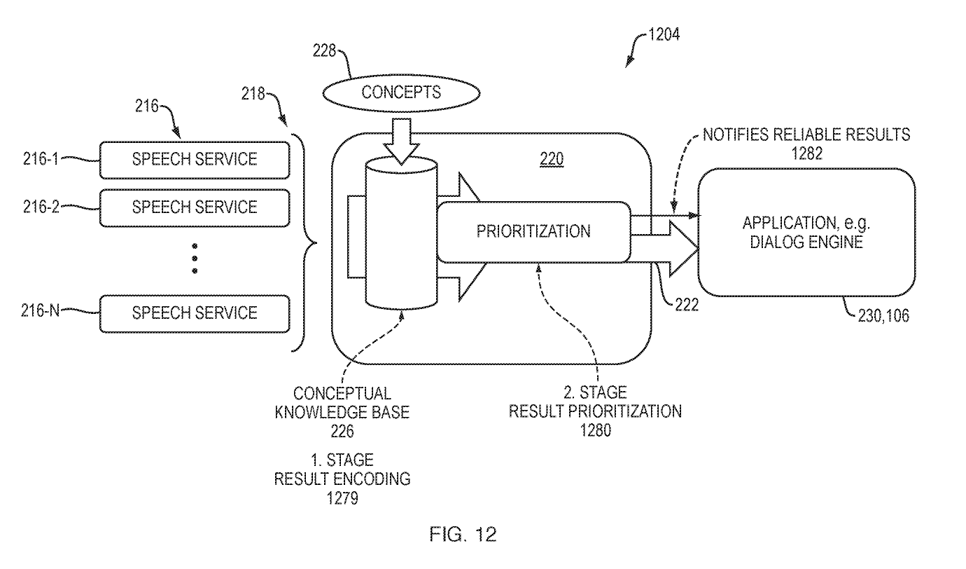

FIG. 12 is a block diagram illustrating an example system for handling results received from plural speech services. System 1204 for handling results received asynchronously from plural speech services includes an assessment (e.g., result prioritization) module 1280 and an output module 222. The assessment module 1280 is configured to assess speech service results 218 received, e.g., asynchronously, from plural speech services 216 to determine, based on a reliability measure, whether there is a reliable result among the speech service results received. If there is a reliable result, the output module 222 provides the reliable result to an application module 230, 106, e.g., a dialog module or user interface. The system 1204 can include an encoder 1279 to represent the speech service results in a unified conceptual knowledge base 226 according to concepts 228. The assessment module 1280 can be configured to assess e.g., prioritize, the speech service results by determining, for each concept of the unified conceptual knowledge base, whether the knowledge represented by the concept is reliable for a given concept query of the application module 230, 106. Prioritization can be built on top of the conceptual knowledge base. For example, while the conceptual knowledge base is built up, priority information can be extracted or derived from the results. The priority information can be passed to the dialog, or the user, along with the results.

An embodiment of the invention is realized as a second stage, e.g., an assessment module 1280, of the priority encoder 220. This module can be part of a modular speech processing system, such as the Dragon Drive Framework. As illustrated in FIG. 12, the module can comprise two stages. The first stage 1279 computes, e.g., encodes results into, a unified conceptual knowledge base whenever a speech service delivers a result. This stage is described above in Section 1 “Representing results from various speech services as a unified conceptual knowledge base.” The second stage 1280, which assesses and prioritizes results, is addressed in this section. The second stage 1280 takes a decision regarding the results from the speech services, e.g. which and/or whose result is reliable, and provides as an output one or more result(s) when enough results are gathered for a reliable conclusion. It is also possible to avoid the first stage 1279 as long as the conceptual knowledge for all, or at least a sufficient number of, speech services is known. The conclusion is notified (1282) to the succeeding module 230, 106, via an interrupt routine. It is possible to use the first and second stages independently from each other as long as the input specification is fulfilled. The input specification can be the input expected by subsequent module 230, 106. The specification can be considered fulfilled if an output of the priority encoder is according to requirements of the subsequent module. Using just the first stage can be accomplished simply by removing (or inactivating) the second stage. Using just the second stage can be accomplished, for example, if the system has knowledge of the concepts and the expectations. Here, a conceptual knowledge base 226 is used, but in principle, any database or knowledge representation technique can be used. Hence, the second stage can be used without the specific first stage described above.

The specification defines the input, e.g., how to receive results from speech services. “Fulfilled” does also refer to the fact that the systems uses probabilities from speech services. It is useful, and in some instances may be required, that those probabilities are well defined and correct.

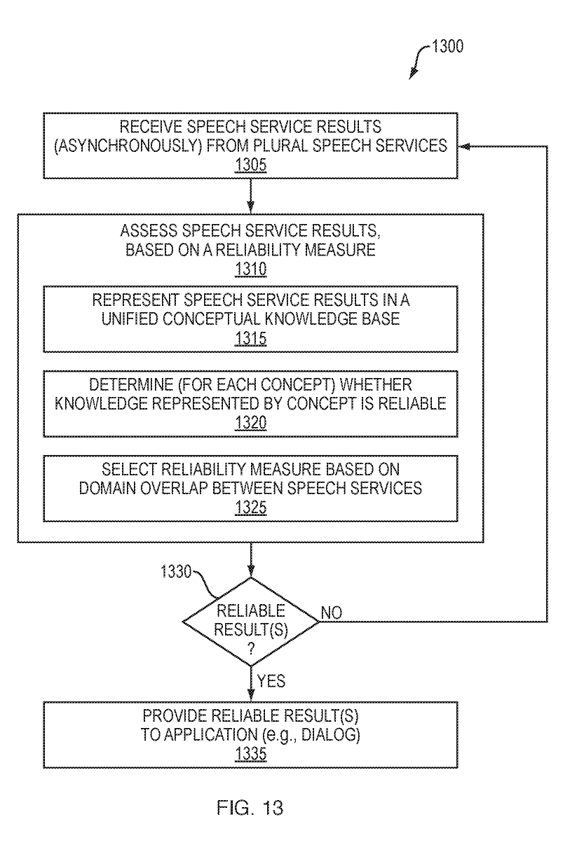

FIG. 13 is a flow diagram illustrating an example method 1300 for handling results received from plural speech services. At 1305, speech service results are received from plural speech services. Typically, the results received asynchronously. At 1310, the speech service results are assessed to then determine (1330), based on a reliability measure, whether there is a reliable result among the speech service results received. If there is a reliable result, the reliable result is provided to an application module at 1335. If there is no reliable result, the method continues to assess the speech service results received (1305).

The method for handling results from plural speech services can further include additional procedures. For example, the method can include the process of representing the speech service results in a unified conceptual knowledge base (1315). Assessing the speech service results can include determining, e.g., for each concept of the unified conceptual knowledge base, whether the knowledge represented by the concept is reliable for a given concept query of the application module (1320). The method can include selecting (1325) the reliability measure based on domain overlap between the speech services (and/or their results). For example, if there is no domain overlap between the speech service results, any one of the results can be considered reliable if (i) all the information that is expected to be represented based on the concept query is represented in the conceptual knowledge base and (ii) no other speech service can contribute a reliable result. If there is full domain overlap between the speech service results, an error expectation of each speech service can be estimated and the reliable result is determined based on evaluation of the error expectation. If there is partial domain overlap between the speech service results, the partial domain overlap can be handled as a case of full domain overlap if the overlap can be determined given the concept query, otherwise as a case of no domain overlap.

The unified conceptual knowledge base of the method of FIG. 13 can be an instance of an ontology and the reliability measure can be indicative of how well a given speech service is able to instantiate the instance. The ontology can be a set of possible semantic concepts along with possible relations among the concepts. The ontology can be configured based on at least one of a speech service specification and speech service routing information. The instance can be constructed iteratively based on the speech service results received from the speech services.

A processing technique is described that continuously assesses a conceptual knowledge base. The process decides for each single concept whether the represented knowledge is reliable or not. The decision is decoupled from the asynchronous processing of speech services. The assessment process considers three information sources: (1) the conceptual knowledge base, (2) the concept query, (3) the activity of speech services. The information is used to distinguish three use-cases:

1. There is no domain overlap between results of speech services

2. There is full domain overlap between results of speech services

3. There is partial domain overlap between results of speech services

Embodiments of the invention can detect all three use-cases, automatically. A use-case is detected by computing the intersection between conceptual knowledge base and concept query. The technique is described with a graphical representation although the implementation is not necessarily based on graphs.

Returning to FIG. 4, the figure is a diagram that illustrates a graphical representation 400 of assessing a conceptual knowledge base given a concept query 454a. Let G be a graph representing the overall ontology of the system including all speech services and all concepts. In FIG. 4, G includes the elements shown at the levels of the speech services 416 and the ontological knowledge 450. The source of the ontology is marked, e.g., it is identifiable which speech service will contribute to which part of the ontology. This is shown by source identifiers 462a and 462b. The unified conceptual knowledge base is an instance M of the ontology G, illustrated as level 452 of graph 400. The contributed speech service is retrievable as well as a reliability measure of how well the speech service was able to instantiate the instance. This measure is a useful tool in a modular framework that includes arbitration between independently developed NLU-enabled modules, such as, for example, the Dragon Drive Framework. Each concept query, such as concept query 454a of FIG. 4, can denote a subset of the ontology, such as key (topic) 450b. The task of a speech system according to an embodiment of the present approach is to deliver the instance that best matches the utterance (e.g., the user's speech input) given the concept query. Hence, an example embodiment queries the instance M given one or more concept queries and assesses the retrieved result. The instance M is assessed given the reliability measure of the speech service. The assessment can be normalized over the concept.

The decision differs for the three use-cases mentioned above:

Use-case 1:

The decision can be taken for successful concept queries. A query is successful if (i) all expected information is represented in the conceptual knowledge base and (ii) when no other speech service can contribute. This means that there exists an instance in M for the concept query. This instance was instantiated from speech services that could contribute to that part of the ontology G. There are two options. First, the decision can be made due to the fact that no other speech service can contribute anymore. Second, the reliability of the instance exceeds the Bayes' decision rule. The computation is generic in the sense that it is not content dependent. It is fully described by G, M and the concept query once the set-up exists.

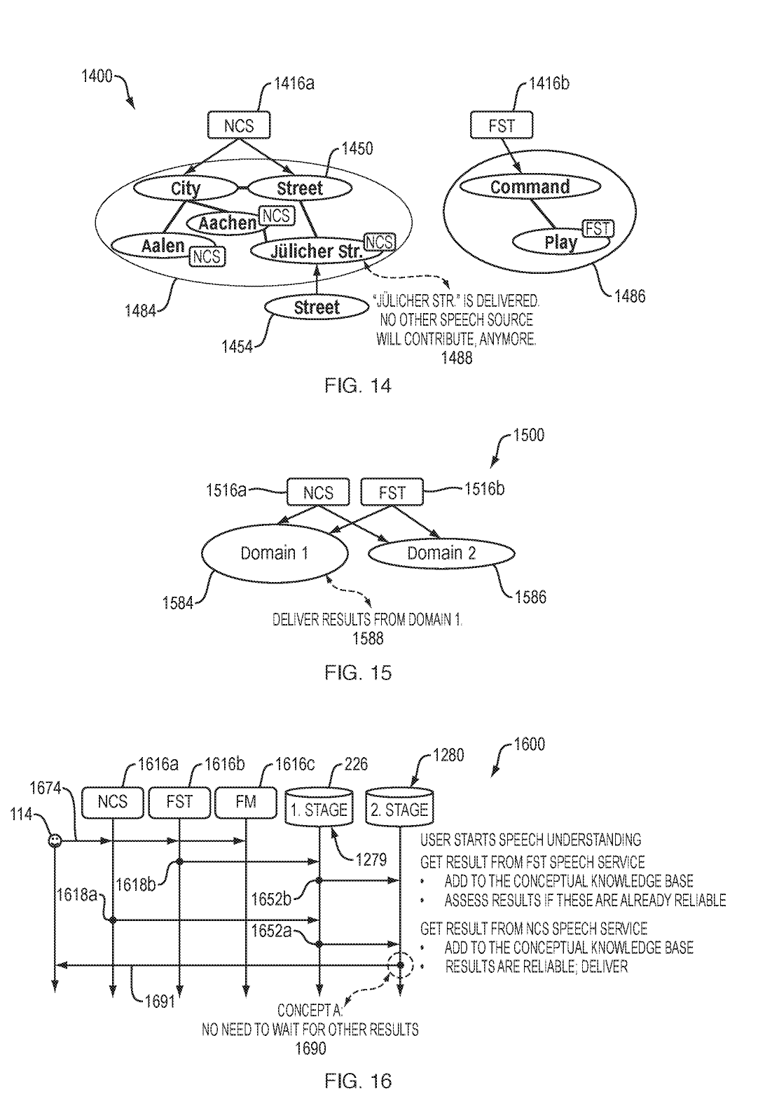

FIG. 14 is a schematic diagram 1400 illustrating an example use-case of no domain overlap between the results from two speech services 1416a (“NCS”) and 1416b (“FST”). Speech service 1416a contributes to domain 1484 and speech service 1416b contributes to domain 1486. In the diagram, concept query 1454 (“Street”) denotes, for example, a navigation query to give a list of street names for the speech input “Aachen Jülicher Str.” The results from speech service 1416a, as represented in the conceptual knowledge base, include a value 1452 (“Jülicher Str.”) associated with key 1450 (“Street”). As shown at 1488, the result “Jülicher Str.” is delivered, because it has been determined that no other speech source, e.g., speech service, will contribute. Here, the only other available source, speech service 1416b, does not provide results in the domain 1484.

FIG. 15 is a schematic diagram 1500 illustrating another example use case of no domain overlap between the results from two speech services 1516a and 1516b, each speech service contributing to both domains 1584 (“Domain 1”) and 1586 (“Domain 2”). Here, the priority encoder delivers results from Domain 1, as indicated at 1588. The decision is based on a probability measure. The probability for the results from the speech services of being in Domain 1 is higher than the probability of being in Domain 2. For example, as illustrated schematically in FIG. 15 by the relative sizes of the oval regions that denote Domains 1 and 2, the probability for Domain 1 is higher than the one for Domain 2 can be.

FIG. 16 is a timing diagram illustrating an example case of a successful concept query, illustrated as decisions process 1600. A user 114 starts speech understanding, e.g., by submitting (1674) a speech input to speech services 1616a, 1616b, 1616c. A result 1618b from speech service 1616b (“FST”) is received first. The priority encoder, in a first stage 1279, processes the result, adding the result and possibly additional information to the conceptual knowledge base 226, as indicated at 1652b. The priority encoder, in a second stage 1280, assesses the (processed) result 1652b to determine if the result and any other results obtained are reliable. Next, a result 1618a is received from speech service 1616a (“NCS”). The priority encoder processes the result, adding to the conceptual knowledge base 226, as indicated at 1652a. The priority encoder assesses the (processed) result 1652a to determine if the result and any other results obtained are reliable. As shown at 1690, a decision is made that the results are reliable given a particular concept query (“Concept A”) and the results are delivered (1691), i.e. provided to an application module and/or the user 114. The results are delivered via an interrupt 1691, illustrated as an event going from right to left in the timing diagram 1600. There is no need to wait for other results, e.g., for results from speech service 1616c (“FM”).

An example is a command and control (C&C) concept which is served by two speech services. One speech service is responsible for general commands like ‘help’, ‘abort’, ‘next’ etc. and another speech service is responsible for music related commands like ‘play’, ‘repeat’ or ‘mute.’ The concept query for C&C comprises all commands. The decision is taken whenever the knowledge base serves the concept query. The decision can be taken according to the Bayes' theorem when no other speech service can change the decision anymore. This also includes the case when no other speech service can contribute to the overall accuracy, as illustrated in FIGS. 14 and 16. There is no need to wait for other speech services which are not related to C&C.

Use-case 2:

Multiple speech services may contribute to the same instance M given a concept query. The overall best accuracy for this use-case with a full domain overlap is only achievable when an instance M is confirmed by the majority of speech service results. Such overlapping instances are identified by analyzing G given all active speech services.

Getting the best accuracy with minimal latency becomes a trade-off problem. An example embodiment optimizes this trade-off continuously. The instance is assessed by evaluating the expected error behavior for speech services given ontological knowledge.

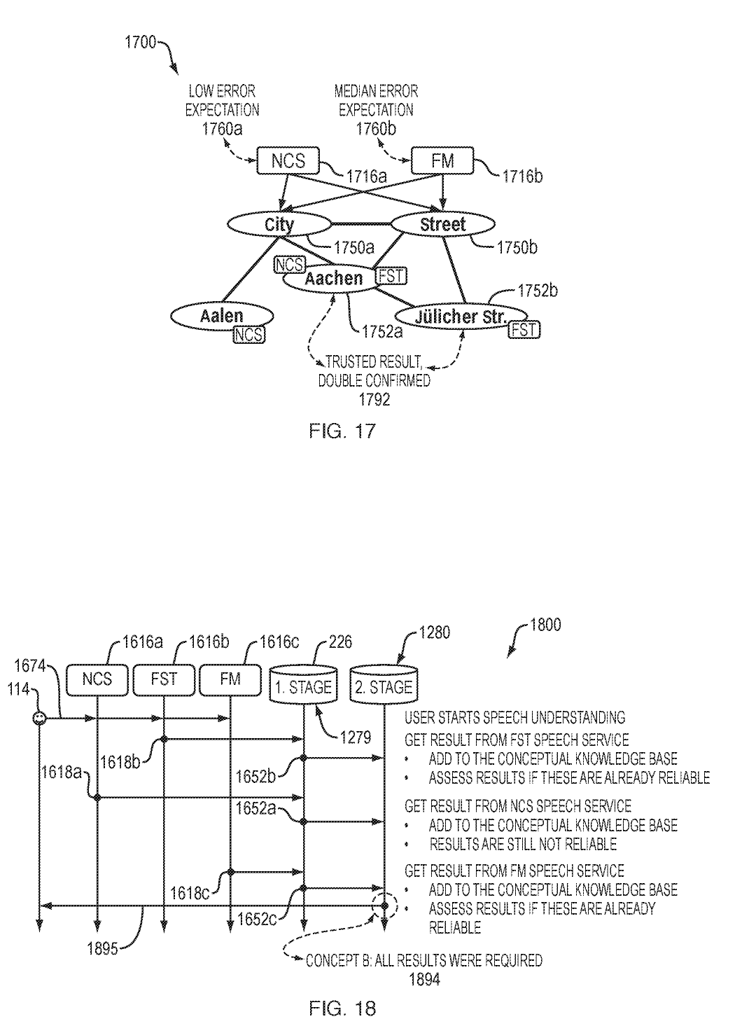

FIG. 17 is a schematic diagram 1700 illustrating graphical representation of a use-case given a full domain overlap between the results from two speech services 1716a (“NCS”) and 1716b (“FM”). Both speech services 1716a and 1716b contribute to the same domain. Here, speech service 1716a is associated with a low error expectation 1760a and speech service 1716b with a median error expectation 1760b. The concept query is, for example, to give a list of street names for the example speech input “Aachen Jülicher Str.” The results from speech service 1716b, as represented in the conceptual knowledge base, include value 1752b (“Jülicher Str.”), associated with key 1750b (“Street”), and value 1752a (“Aachen”), associated with keys 1750b and 1750a (“City”). As indicated at 1792, the result 1752b (“Jülicher Str.”) is considered a trusted result because it is associated with result 1752a that is doubly confirmed, e.g., confirmed by two speech result sources, 1716a and 1716b.

A result from a speech service with low error expectation is prioritized and it becomes unnecessary to wait for further results, e.g., from speech services with higher error expectations. On the other hand, combining speech services with high error expectation might be already sufficient. Waiting for a speech service with lower error expectation will not further increase the accuracy, significantly. The latency depends on the speech service and its reliability given a queried concept. An example embodiment automatically determines concept queries where it would be better to wait for confirmation by additional speech services.

FIG. 18 is a timing diagram illustrating an example decision process 1800 that includes waiting for results from all speech services. A user 114 starts speech understanding, e.g., by submitting (1674) a speech input to speech services 1616a, 1616b and 1616c. A result 1618b from speech service 1616b (“FST”) is received first. The priority encoder, in a first stage 1279, processes the result, adding the result and possibly additional information to the conceptual knowledge base 226, as indicated at 1652b. The priority encoder, in a second stage 1280, assesses the (processed) result 1652b to determine if the result and any other results obtained are reliable. Next, a result 1618a is received from speech service 1616a (“NCS”). The priority encoder processes the result, adding to the conceptual knowledge base 226, as indicated at 1652a, and assesses the (processed) result 1652a to determine if the result and any other results obtained are reliable. Here, the results are still not reliable at this phase in the process, so no results are delivered. Next, a result 1618c is received from speech service 1616c (“FM”). The priority encoder processes the result, adding to the conceptual knowledge base 226, as indicated at 1652c. The priority encoder again assesses the (processed) result 1652c to determine if the result and any other results obtained are reliable. As shown at 1894, a decision is made that the results are reliable given a particular concept query (“Concept B”) and one or more of the results are delivered (1895), e.g., provided to an application module and/or the user 114. Here, all results 1618a, 1618b, and 1618c were required to make the decision to provide the results.

The error expectation can be estimated from field and user data, e.g., how often a user confirmed a correct recognition. Field data can be used to continuously improve and evaluate speech services. This information can be used to estimate an expected error behavior for each speech service. This also enables to add functionality over the time by successively increasing the reliability measure. In contrast, user data can be used for finer, e.g., more granular, estimation, e.g., when user behavior indicates that a certain concept, e.g., city, is most often confirmed and available from one certain speech service. The system can continuously decrease the latency during this learning process.

The error expectation for speech services can also be related to other constraints, e.g., current network bandwidth, computational power and the like. Also, the signal-to-noise ratio (e.g., speech-to-noise ratio) can be used to compute an error expectation, e.g., when a speech service is getting more reliable for a decreasing signal-to-noise ratio or vice versa. The expectation measure can also be based on a classifier, e.g., using statistical models trained on various sources. Note that this error expectation measure can be computed independently from the speech service result itself. This allows conclusions on speech services in advance, e.g., whether it is beneficial to wait to significantly improve the overall accuracy or not, to achieve a minimal latency.

Use-case 3:

This use-case can be reduced to be use-case 1 or 2 if the overlap can be determined given a concept query. Results from speech services may instantiate the same concept query as well as other parts. The overlap is fully described by the ontological knowledge.

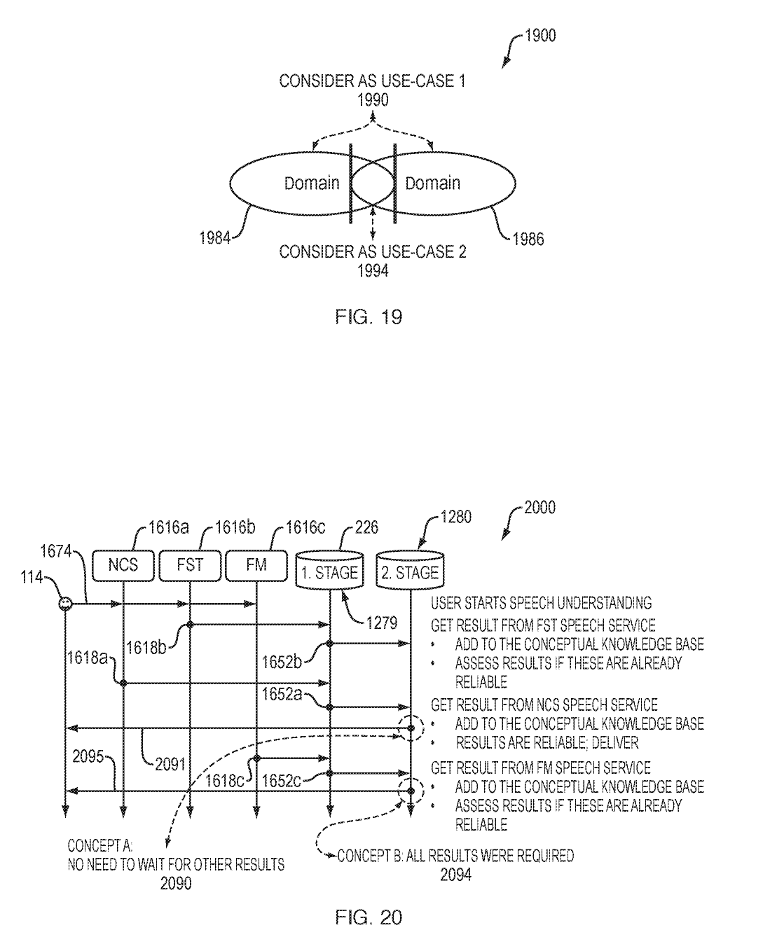

FIG. 19 is a schematic diagram 1900 illustrating an example use case of partial domain overlap between results of speech services. As shown, domain 1984 partially overlaps with domain 1986. The overlap can be considered, and results handled, as use-case 2, as indicated at 1994. The other (non-overlapping) parts can be considered, and results handled, as use-case 1, as indicated at 1990.

Examples of domain overlap are found in command and control (C&C). For example, the music speech service may not only provide music related commands but also enable a voice search. The C&C concept does not need to wait when the general speech service already denotes a contradicted command. A decision can be taken according to use-case 1. On the other hand, the music speech service may compete with a media speech service with identical functionality that expects the command and control part. In that case, the decision process needs to be done according to use-case 2.

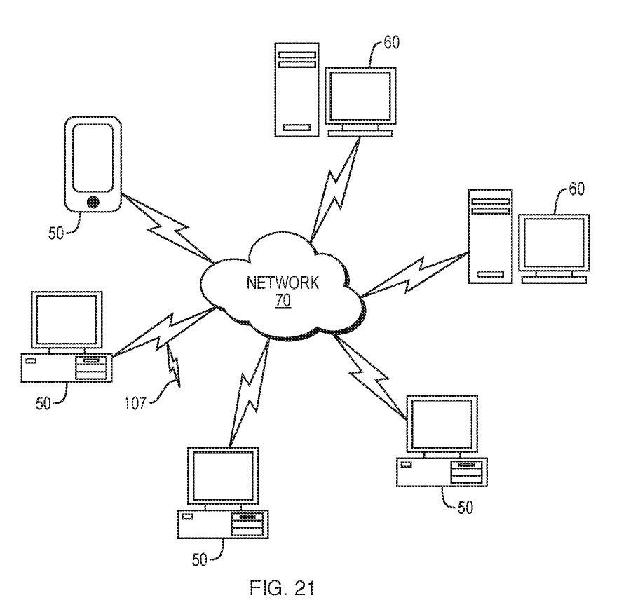

FIG. 20 is a timing diagram illustrating timing of an example decision process 2000 for two concepts, Concept A and Concept B. As in the decisions processes 1600 and 1800 described above, a user 114 starts (1674) speech understanding, e.g., by submitting an audio input or other speech input to speech services 1616a, 1616b, 1616c. A result 1618b from speech service 1616b (“FST”) is received first. The priority encoder, in a first stage 1279, processes the result, adding the result and possibly additional information to the conceptual knowledge base 226, as indicated at 1652b. The priority encoder, in a second stage 1280, assesses the (processed) result 1652b to determine if the result and any other results obtained are reliable. Next, a result 1618a is received from speech service 1616a (“NCS”). The priority encoder processes the result, adding to the conceptual knowledge base 226, as indicated at 1652a. The priority encoder assesses the (processed) result 1652a to determine if the result and any other results obtained are reliable. Here, as shown at 2090, the results are considered reliable given the first concept query (“Concept A”). One or more results available at that time are delivered (2091), as there is no need to wait for additional results for Concept A. Subsequently, a result 1618c is received from speech service 1616c (“FM”). The priority encoder processes the result, adding to the conceptual knowledge base 226, as indicated at 1652c. The priority encoder again assesses the (processed) result 1652c to determine if the result and any other results obtained are reliable. As shown at 2094, a decision is made that the results are reliable given a particular concept query (“Concept B”) and one or more of the results are delivered (2095), e.g., provided to an application module and/or the user 114. For Concept B, all results 1618a, 1618b, and 1618c were required to make the decision to provide the results.

An example embodiment assesses results automatically given an ontology G and an instance M. The instance M is based on results from speech services and be constructed iteratively. The ontology G is configured at start-up time. The ontology is derived from the speech service specification and by speech service routing and configuration information. The concept query is typically provided by the succeeding application. The concept query specifies a concept and defines what information a succeeding module, e.g., a dialog, can process. An example embodiment delivers, per definition, the overall best accuracy with a minimal latency. The latency is decoupled from the speech service but depends on the recognized and demanded content. An interrupt notifies a reliable result given a concept. In a preferred embodiment, a succeeding module, such as a dialog, needs not implement any method to control speech services based on asynchronous results, decoupling the succeeding module from the processing of the speech service results. The succeeding module does not need to know how many or how few, or what kind of speech services are available.

Using embodiments of the present invention, it is also possible to deliver not just the unified result with information on contributed speech services, but the main speech service with information what part contributed to the decision. This is basically a different representation of the same information. The first one is ordered by the recognized information and the second one is ordered by the contributed speech service.

FIG. 21 illustrates a computer network or similar digital processing environment in which embodiments of the present invention may be implemented.

Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

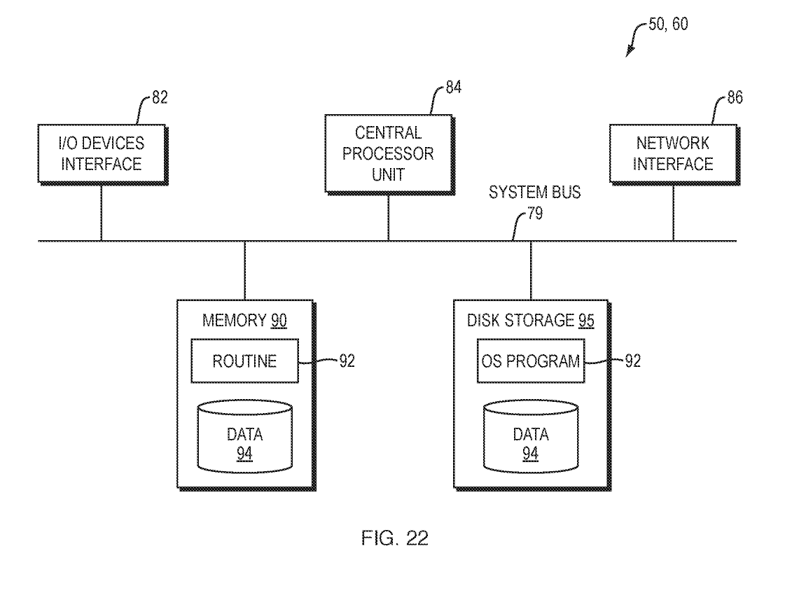

FIG. 22 is a diagram of an example internal structure of a computer (e.g., client processor/device 50 or server computers 60) in the computer system of FIG. 21. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 21). Memory 90 provides volatile storage for computer software instructions 92 and data 94 used to implement an embodiment of the present invention (e.g., processing results from plural speech service, handling results received asynchronously from plural speech service, etc., as detailed above). Disk storage 95 provides non-volatile storage for computer software instructions 92 and data 94 used to implement an embodiment of the present invention. A central processor unit 84 is also attached to the system bus 79 and provides for the execution of computer instructions.

In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals may be employed to provide at least a portion of the software instructions for the present invention routines/program 92.

In alternative embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

1. A method of processing results from plural speech services, the method comprising:
a) receiving speech service results from plural speech services and service specifications corresponding to the speech service results, the results being at least one data structure representing information according to functionality of the speech services, the service specifications describing the data structure and its interpretation for each speech service;
b) encoding the speech service results into a unified conceptual knowledge representation of the results based on the service specifications; and
c) providing the unified conceptual knowledge representation to an application module.

2.-18. (canceled)

19. A system for processing results from plural speech services, the system comprising:
a) an input module configured to receive speech service results from plural speech services and service specifications corresponding to the speech services, the results being at least one data structure representing information according to functionality of the speech services, the service specifications describing the data structure and its interpretation for each speech service;
b) a priority encoder configured to encode the speech service results into a unified conceptual knowledge representation of the results based on the service specifications; and
c) an output module configured to provide the unified conceptual knowledge representation to an application module.

20. A computer program product comprising a non-transitory computer readable medium storing instructions for performing a method for processing results from plural speech services, the instructions, when executed by a processor, cause the processor to:
a) be enabled to receive speech service results from plural speech services and service specifications corresponding to the speech services, the results being at least one data structure representing information according to functionality of the speech services, the service specifications describing the data structure and its interpretation for each speech service;
b) encode the speech service results into a unified conceptual knowledge representation of the results based on the service specifications; and
c) provide the unified conceptual knowledge representation to an application module.

21. A method for handling results received asynchronously from plural speech services, the method comprising:
a) assessing speech service results received asynchronously from plural speech services to determine, based on a reliability measure, whether a reliable result is among the speech service results received; and
b) if a reliable result is among the speech service results received, providing the reliable result to an application module, otherwise, continuing to assess the speech service results received.

22. The method of claim 21, further comprising representing the speech service results in a unified conceptual knowledge base, and wherein assessing the speech service results includes determining for each concept of the unified conceptual knowledge base whether the knowledge represented by the concept is reliable for a given concept query of the application module.

23. The method of claim 21, wherein the unified conceptual knowledge base is an instance of an ontology, the reliability measure being indicative of how well a given speech service is able to instantiate the instance.

24. The method of claim 23, wherein the ontology is a set of possible semantic concepts along with possible relations among the concepts.

25. The method of claim 24, further comprising configuring the ontology based on at least one of a speech service specification and speech service routing information.

26. The method of claim 23, further comprising constructing the instance iteratively based on the speech service results received from the speech services.

27. The method of claim 21, further comprising selecting the reliability measure based on domain overlap between the speech service results.

28. The method of claim 27, wherein, if there is no domain overlap between the speech service results, any one of the results is considered reliable if (i) all the information that is expected to be represented based on the concept query is represented in the conceptual knowledge base and (ii) no other speech service can contribute a reliable result.

29. The method of claim 27, wherein, if there is full domain overlap between the speech service results, an error expectation of each speech service is estimated and the reliable result is determined based on evaluation of the error expectation.

30. The method of claim 29, wherein the error expectation is estimated from at least one of field data and user data relating to the speech services.

31. The method of claim 29, wherein the error expectation is estimated based on a signal-to-noise ratio or a classifier.

32. The method of claim 29, further comprising prioritizing speech service results from speech services with low error expectation.

33. The method of claim 29, further comprising automatically determining whether a combination of speech service results from speech services with high error expectation is sufficiently reliably or whether there is a need to wait for results from additional speech services.

34. The method of claim 27, wherein, if there is partial domain overlap between the speech service results, the partial domain overlap is handled as a case of full domain overlap if the overlap can be determined given the concept query, otherwise as a case of no domain overlap.

35. A system for handling results received asynchronously from plural speech services, the system comprising:
a) an assessment module configured to assess speech service results received asynchronously from plural speech services to determine, based on a reliability measure, whether a reliable result is among the speech service results received; and
b) an output module configured to provide, if a reliable result is among the speech service results received, the reliable result to an application module.

36. The system of claim 35, further comprising an encoder configured to represent the speech service results in a unified conceptual knowledge base, and wherein the assessment module is configured to assess the speech service results by determining for each concept of the unified conceptual knowledge base whether the knowledge represented by the concept is reliable for a given concept query of the application module.

37. The system of claim 35, wherein the unified conceptual knowledge base is an instance of an ontology, the reliability measure being indicative of how well a given speech service is able to instantiate the instance.

38. The system of claim 35, wherein the reliability measure is selected based on domain overlap between the speech service results.

39. A computer program product comprising a non-transitory computer readable medium storing instructions for handling results received asynchronously from plural speech services, the instructions, when executed by a processor, cause the processor to:
a) assess speech service results received asynchronously from plural speech services to determine, based on a reliability measure, whether a reliable result is among the speech service results received; and
b) if a reliable result is among the speech service results received, provide the reliable result to an application module, otherwise, continue to assess the results received.
